(19) United States
(12) Patent Application Publication
(10) Pub. No.: US 2008/0048581 A1
(43) Pub. Date: Feb. 28, 2008

(54) ELECTRONIC BALLAST AND METHOD FOR DRIVING FLUORESCENT LAMP

(75) Inventor: Chih-Shun Lee, Taipei City (TW)

Correspondence Address: J C PATENTS, INC., 4 VENTURE, SUITE 250, IRVINE, CA, 92618, US

(73) Assignee: BEYOND INNOVATION TECHNOLOGY CO., LTD., Taipei City (TW)

(21) Appl. No.: 11/625,995

(22) Filed: Jan. 23, 2007

(30) Foreign Application Priority Data
Aug. 22, 2006 (TW) 95130782

(51) Int. Cl. H05B 41/36

(52) U.S. Cl. 315/291

(57) ABSTRACT

An electronic ballast comprising a pulse width modulation (PWM) unit and a power-converting unit is provided. The PWM unit is used for generating a PWM signal to the power-converting unit so that the power-converting unit can generate a driving signal to drive and light up the fluorescent lamp according to the PWM signal. Specially, the duty cycle of the PWM signal is varied with time in a pre-heating period of the fluorescent lamp. In addition, the present invention further includes a detecting module for detecting a working voltage and a working current of the fluorescent lamp to determine whether the fluorescent lamp works normally. When the fluorescent lamp cannot work normally, the PWM signal generated by the PWM unit is disabled through the detecting module.

### CROSS-REFERENCE TO RELATED APPLICATION

This application claims the priority benefit of Taiwan application serial no. 95130782, filed Aug. 22, 2006. All disclosure of the Taiwan application is incorporated herein by reference.

### BACKGROUND OF THE INVENTION

1. Field of the Invention

The present invention relates to an electronic ballast, and more particularly, to an electronic ballast that uses a pulse width modulation (PWM) signal with variable duty cycle to drive a fluorescent lamp.

2. Description of Related Art

In very early days, light was a very important issue in our everyday life. After Thomas Edison invented the electric light bulb, lighting equipment has evolved one big step ahead into a new milestone. At present, a variety of different light sources, from small semiconductor light-emitting diodes to big neon signs lining major streets of our big cities, are available. All these light sources also add considerable colors to this world.

Among the throng of lighting equipment, fluorescent lamps are the most commonly used. From families to office buildings, fluorescent lamps are installed inside all kinds of architectural designs to serve as the principle sources of illumination. In general, fluorescent lamps need to have electronic ballast to increase light emission efficiency and extend the life span of lamp tubes.

As shown in FIG. 1, the conventional electronic ballast has a resonant cavity 100 for driving a fluorescent lamp 102. In the pre-heating period of the fluorescent lamp, the resonant cavity 100 in the conventional electronic ballast receives a pulse width modulation (PWM) signal K1 with a fixed duty cycle t1. By adjusting the operating frequency of the PWM signal K1 so that the operating frequency of the PWM signal K1 changes from a high frequency to a lower frequency, the fluorescent lamp is activated. After the resonant cavity of the electronic ballast has received the PWM signal K1, a sinusoidal driving signal I1 is generated by a capacitor Cs and an inductor Ls to drive and light up the fluorescent lamp 102.

As mentioned above, the conventional electronic ballast still uses a PWM signal with a fixed duty cycle so that a large inrush current is often produced. As a result of the sudden inrush of a large current, the devices inside the electronic ballast easily burnout.

Moreover, a large number of lamp tubes are being installed inside most buildings. Using an office building as an example, the required illumination is so substantial that a large number of fluorescent lamps are required. When these fluorescent lamps are activated, there will be a large transient inrush of current into the electronic resonant cavity 100. In the transient when the resonant cavity 100 is just activated, because the operating frequency of the PWM signal K1 is a high frequency, the capacitor Cp is at high frequency, low impedance state. Therefore, almost the entire driving current I1 will flow through the capacitor Cp and may ultimately lead to the burnout of the capacitor Cp.

Thus, how to provide an electronic ballast capable of preventing the foregoing problem is an important topic of research.

### SUMMARY OF THE INVENTION

Accordingly, at least one objective of the present invention is to provide an electronic ballast for driving a fluorescent lamp capable of limiting the size of current flowing in a pre-heating period to prevent the burnout of devices inside the electronic ballast.

According to another aspect of the present invention, a method of driving a fluorescent lamp capable of controlling the size of an initial current through controlling the duty cycle of a pulse width modulation (PWM) signal is provided.

To achieve these and other advantages and in accordance with the purpose of the invention, as embodied and broadly described herein, the invention provides an electronic ballast. The electronic ballast includes a pulse width modulation (PWM) unit and a power-converting unit. The PWM unit is used for generating a PWM signal. In a pre-heating period of the fluorescent lamp, the duty cycle of the PWM signal is varied with time. According to the PWM signal, the power-converting unit generates a driving signal to drive the fluorescent lamp.

In addition, the method of driving the fluorescent lamp in the present invention includes generating a PWM signal whose duty cycle is varied with time when pre-heating the fluorescent lamp and generating a driving signal according to the PWM signal to drive and light up the fluorescent lamp.

In one embodiment of the present invention, the duty cycle of the PWM signal is increased with time. When the fluorescent lamp works normally, the duty cycle of the PWM signal is fixed.

As mentioned above, the duty cycle of the PWM signal is varied with time. Therefore, the present invention is able to shorten the duty cycle of the PWM signal in the initial period and limit the current flowing through the electronic ballast in the same period.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a conventional electronic ballast activating a fluorescent lamp.

FIG. 2 is a circuit block diagram of an electronic ballast according to one preferred embodiment of the present invention.

FIG. 3 is a circuit diagram of an electronic ballast according to one preferred embodiment of the present invention.

FIG. 4 is a diagram showing an electronic ballast activating a fluorescent lamp according to one preferred embodiment of the present invention.

FIG. 5 is a flow diagram showing a method for driving a fluorescent lamp according to one preferred embodiment of the present invention.

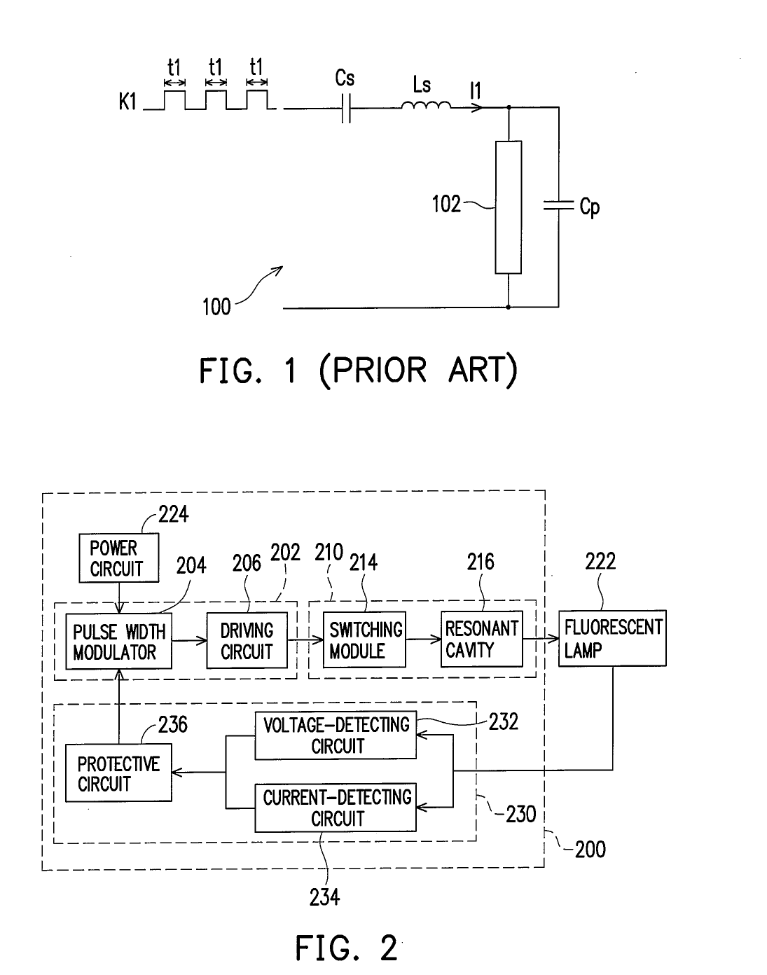

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a circuit block diagram of an electronic ballast according to one preferred embodiment of the present invention. As shown in FIG. 2, the electronic ballast 200 in the present embodiment is used for driving a fluorescent lamp. The electronic ballast 200 includes a pulse width modulation (PWM) unit 202 and a power-converting unit 210. In the present embodiment, the duty cycle of the PWM signal generated by the PWM unit 202 is varied with time when the fluorescent lamp is in a pre-heating period.

The PWM unit 202 has a pulse width modulator 204 and a driving circuit 206. The pulse width modulator 204 is used for generating a PWM signal. The driving circuit 206 amplifies the PWM signal and transmits the amplified PWM signal to the power-converting unit 210. Thus, the power-converting unit 210 generates a driving signal according to the PWM signal generated by the PWM unit 202 to drive and light up the fluorescent lamp 222. In the embodiment of the present invention, the fluorescent lamp 222 is an illuminating apparatus such as a fluorescent lamp tube. The present invention does not provide any restriction on the type of illuminating apparatus.

The power-converting unit 210 includes a switching module 214 with a plurality of power switches and a resonant cavity 216. When the power-converting unit 210 receives the PWM signal generated by the PWM unit 202, the switching module 214 determines if it conducts according to the output from the driving circuit 206 so that a square wave control signal is generated to the resonant cavity 216. The working theory will be described in more detail later on. Furthermore, when the switching module 214 outputs the square wave control signal to the resonant cavity 216, the resonant cavity 216 may generate a sinusoidal driving signal to drive and light up the fluorescent lamp 222 according to the square wave control signal.

In addition, the electronic ballast 200 may further include a power circuit 224 and a detecting module 230. The power circuit 224 may supply a stable DC source to the pulse width modulator 204 for generating PWM signal. The detecting module 230 is used for detecting the working current and the working voltage of the fluorescent lamp 222 and generating a detection result to the PWM unit 202. Thus, whether the PWM unit 202 outputs the PWM signal can be adjusted according to the output from the detecting module 230 so that a fluorescent lamp working under abnormal working conditions is protected.

In the present embodiment, the detecting module 230 includes a voltage-detecting circuit 232, a current-detecting circuit 234 and a protective circuit 236. The voltage-detecting circuit is used for detecting the working voltage of the fluorescent lamp 222 and the current-detecting circuit 234 is used for detecting the working current of the fluorescent lamp 222 so that whether the fluorescent lamp 222 works normally can be determined.

When the voltage-detecting circuit 232 detects that the fluorescent lamp 222 cannot work normally, the output from the voltage-detecting circuit 232 will exceed a preset level. Meanwhile, the protective circuit 236 will output a detecting signal to the PWM unit 202 to disable the output of the PWM signal. Obviously, the voltage-detecting circuit may detect an output lower than a preset level and output a detecting signal to the PWM unit 202 to disable the output of the PWM signal.

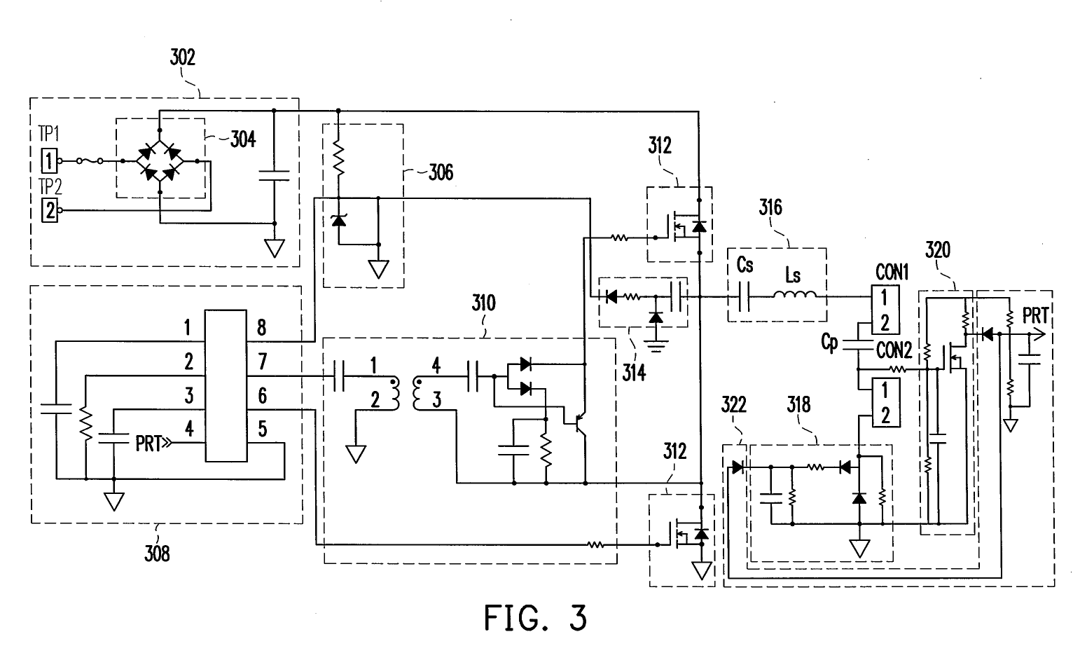

FIG. 3 is a circuit diagram of an electronic ballast according to one preferred embodiment of the present invention. As shown in FIG. 3, the power circuit 302 includes leads TP1 and TP2 connected to a stable power source such as a utility power source. When power is supplied to the power circuit 302 through the leads TP1 and TP2, it first passes through a bridge-type rectifying structure 304 and then outputs to a voltage-regulating circuit 306 and a power switch 312.

In addition, the output of the voltage-regulating circuit 306 is coupled to the pulse width modulator 308. According to the output (the output is a DC voltage in the present embodiment) of the voltage-regulating circuit 306, the pulse width modulator 308 outputs a PWM signal whose duty cycle is varied with time. The pulse width modulator 308 outputs the PWM signal to a driving circuit 310 so that the driving circuit 310 can switch the power switch 312 to generate a square wave signal according to the PWM signal.

In the present embodiment, the power switch 312 is coupled to a rectifying circuit 314 and a resonant cavity circuit 316. According to FIG. 3, the resonant cavity circuit 316 may comprise a capacitor Cs and an inductor Ls for converting the square signal from the power switch into a sinusoidal driving signal and outputting to a lead CON1.

The lead CON1 is coupled to another lead CON2 through a capacitor Cp. The two leads CON1 and CON2 are coupled to the two terminals of a fluorescent lamp (not shown). Thus, the output of the resonant cavity circuit 316 is able to drive and light up the fluorescent lamp through the leads CON1 and CON2.

Furthermore, the lead CON2 is also coupled to a current-detecting circuit 318 and a voltage-detecting circuit 320. The current-detecting circuit 318 and the voltage-detecting circuit 320 detect the working current and the working voltage of the fluorescent lamp through the lead CON2. When the fluorescent lamp cannot work normally, this will cause the working current and the working voltage to change. When either one of the current-detecting circuit 318 and the voltage-detecting circuit 320 detects that the fluorescent lamp cannot work normally, the protective circuit 322 will change the state of the detecting signal PRT so that the generation of the PWM signal by the pulse width modulator 308 is disabled.

In the present embodiment, the detection of a high detecting signal PRT by the pulse width modulator 308 indicates that the fluorescent lamp works normally. Conversely, the detection of a low detecting signal PRT by the pulse width modulator 308 indicates that the fluorescent lamp cannot work normally. Therefore, the generation of the PWM signal is disabled.

Although the current-detecting circuit 318 and the voltage-detecting circuit 320 are simultaneously disposed in the present embodiment, the present invention need not be limited in this way. In real applications, either the current-detecting circuit 318 or the voltage-detecting circuit 320 may be used to save the cost of production.

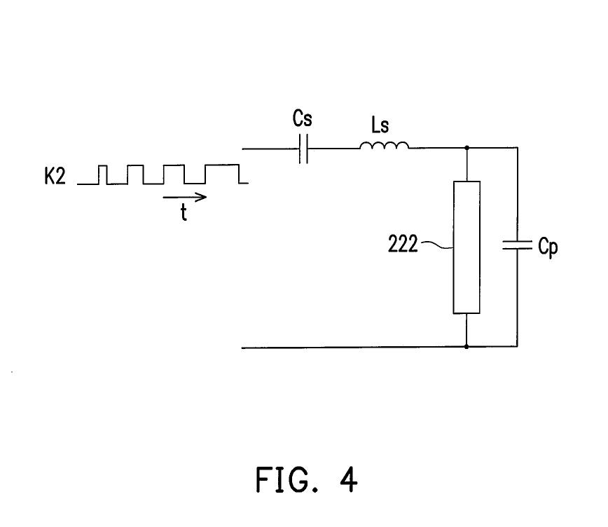

FIG. 4 is a diagram showing an electronic ballast activating a fluorescent lamp according to one preferred embodiment of the present invention. As shown in FIG. 4, the PWM signal K2 whose duty cycle is varied with time may be generated, for example, by the PWM unit 202 as shown in FIG. 2. In the present invention, the PWM signal K2 is used for controlling, for example, the power switch 312 as shown in FIG. 3. When the PWM signal K2 is in the duty cycle, the power switch 312 is in a conducting state. On the other hand, when the PWM signal K2 is not in the duty cycle, the power switch 312 is shut down. Thus, the power switch 312 is able to output a square control signal.

It can be seen from FIG. 4 that the duty cycle of the PWM signal K2 is relatively small in the initial period so that the conducting period of the power switch 312 is shorter. Thus, the amount of current flowing into the electronic ballast in the initial period is limited and prevents the capacitor Cp from burning out during the initial operation (the capacitor Cp is in a high frequency and low impedance state). However, with the passage of time, the duty cycle of the PWM signal K2 grows longer. After the fluorescent lamp 222 has stabilized and works in a stabile condition, the duty cycle of the PWM signal K2 is fixed.

In addition, because the amount of current flowing into the conventional electronic ballast during the initial operating period is large, conspicuous harmonic influence will be produced through the action provided by the capacitor Cs and the inductor Ls when the power source is a utility power source. Since the present invention is able to limit the size of initial current, the initial current passing through the capacitor Cs and the inductor Ls is quite limited. Hence, the influence of harmonics is effectively suppressed.

In the present embodiment, the frequency of the PWM signal generated by the PWM unit 202 is also varied from a high frequency to a low frequency with time in the pre-heating period of the fluorescent lamp to produce a soft activation. Yet, the PWM signal is maintained at a fixed frequency when the fluorescent lamp is stabilized and works normally.

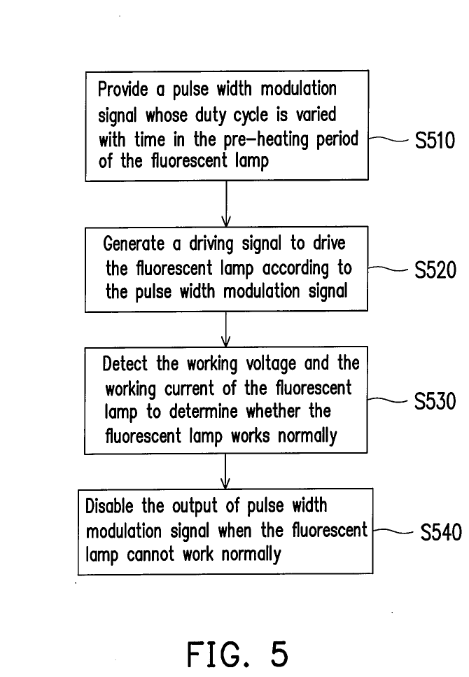

FIG. 5 is a flow diagram showing a method for driving a fluorescent lamp according to one preferred embodiment of the present invention. The method of driving the fluorescent lamp in the present embodiment can be applied to the electronic ballast 200 in FIG. 2. The driving method includes the following steps. First, in step S510, a PWM signal is provided in a fluorescent lamp pre-heating period. The duty cycle of the PWM signal is varied with time, for example, from a smaller to a larger duty cycle. The PWM signal may be provided through the foregoing PWM unit 202. In addition, when the fluorescent lamp works normally, the duty cycle of the PWM signal is fixed.

Next, in step S520, the power-converting unit 210 generates a sinusoidal driving signal to drive the fluorescent lamp according to the PWM signal.

Next, in step S530, by detecting the working voltage and the working current of the fluorescent lamp through the detecting unit 230, whether or not the fluorescent lamp works normally is determined. Next, in step S540, when it is determined that the fluorescent lamp cannot work normally, the output of the PWM signal is disabled to provide the required protection.

In addition, in the present embodiment, the step 510 may further include the following sub-steps. First, the frequency of the PWM signal is varied from a high frequency to a low frequency with time in the pre-heating period of the fluorescent lamp to produce a soft activation. Furthermore, the PWM signal is maintained at a fixed frequency when the fluorescent lamp is stabilized and works normally.

The step S520 may further include the following sub-steps. The original PWM signal is amplified, and a square wave control signal is generated according to the amplified PWM signal. Next, a sinusoidal driving signal is generated to drive and light up the fluorescent lamp according to the square wave control signal.

In summary, the present invention is capable of generating a PWM signal whose duty cycle is varied with time so that the size of the initial current is limited. Thus, the present invention not only prevents the device from having to withstand a larger initial operating current, but also effectively suppresses the influence of harmonic components.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic ballast, suitable for driving a fluorescent lamp, comprising:
a pulse-width modulation (PWM) unit, for generating a PWM signal, wherein a duty cycle of the PWM signal is varied with time when the fluorescent lamp is in a pre-heating period; and
a power-converting unit, for generating a driving signal to drive the fluorescent lamp according to the PWM signal.

2. The electronic ballast of claim 1, wherein the duty cycle of the PWM signal is varied from a small duty cycle to a large duty cycle with time.

3. The electronic ballast of claim 1, wherein a duty cycle of the PWM signal is fixed when the fluorescent lamp works normally.

4. The electronic ballast of claim 1, wherein a frequency of the PWM signal is varied with time when the fluorescent lamp is in the pre-heating period.

5. The electronic ballast of claim 4, wherein a frequency of the PWM signal is varied from a high frequency to a low frequency with time.

6. The electronic ballast of claim 1, wherein the PWM unit comprises:
a pulse width modulator for generating the PWM signal; and
a driving circuit for receiving the PWM signal, amplifying the PWM signal and transmitting the amplified PWM signal to the power-converting unit.

7. The electronic ballast of claim 6, wherein the power-converting unit comprises:
a switching module, comprising a plurality of power switches, for receiving an external input voltage and the PWM signal, and converting the input voltage into a square wave signal according to the PWM signal; and
a resonant cavity, electrically coupled to the switching module, for converting the square wave signal into the driving signal to drive the fluorescent lamp.

8. The electronic ballast of claim 7, wherein the driving signal is a sinusoidal signal.

9. The electronic ballast of claim 7, wherein a portion of the power switches are conducting when the PWM signal is in the duty cycle and the rest power switches are shut down when the PWM signal is in the non-duty cycle in order to generate a square wave signal.

10. The electronic ballast of claim 1, further comprising a detecting module used for detecting a working voltage and a working current of the fluorescent lamp so that an output of the PWM signal is disabled by the PWM unit when the fluorescent lamp is not able to work normally.

11. The electronic ballast of claim 10, wherein the detecting module comprises:
a voltage-detecting circuit, for detecting the working voltage of the fluorescent lamp;
a current-detecting circuit, for detecting the working current of the fluorescent lamp; and
a protective circuit, for receiving outputs from the voltage-detecting circuit and the current-detecting circuit, and generating a detecting signal to the PWM unit according to the outputs.

12. The electronic ballast of claim 11, wherein the protective circuit generates the detecting signal when the output from the voltage-detecting circuit is lower than or higher than a preset level.

13. The electronic ballast of claim 11, wherein the protective circuit generates a detecting signal when the output from the current-detecting circuit is lower than or higher than a preset level.

14. The electronic ballast of claim 1, further comprising a power circuit for providing power to the PWM unit.

15. The electronic ballast of claim 1, further comprising a capacitor connected in parallel with the fluorescent lamp.

16. A method of driving a fluorescent lamp, comprising:
providing a pulse width modulation (PWM) signal such that a duty cycle of the PWM signal is varied with time when the fluorescent lamp is in a pre-heating state; and
generating a driving signal to drive the fluorescent lamp according to the PWM signal.

17. The method of driving the fluorescent lamp of claim 16, wherein the duty cycle of the PWM signal is varied from a small duty cycle to a large duty cycle with time.

18. The method of driving the fluorescent lamp of claim 16, further comprising:
maintaining a fixed duty cycle for the PWM signal when the fluorescent lamp works normally.

19. The method of driving the fluorescent lamp of claim 16, wherein the frequency of the PWM signal is varied from a high frequency to a low frequency with time.

20. The method of driving the fluorescent lamp of claim 16, further comprising:
maintaining a fixed frequency for the PWM signal when the fluorescent lamp works normally.

21. The method of driving the fluorescent lamp of claim 16, wherein the step for generating the PWM signal comprises:
detecting a working voltage and a working current of the fluorescent lamp to determine whether the fluorescent lamp works normally; and
disabling the PWM signal when the fluorescent lamp is unable to work normally is detected.

22. The method of driving the fluorescent lamp of claim 16, wherein the step for providing the PWM signal further comprising:
amplifying the PWM signal.

23. The method of driving the fluorescent lamp of claim 16, wherein the step for driving the fluorescent lamp further comprises:
generating a square wave signal according to the PWM signal; and
converting the square wave signal into a sinusoidal driving signal.
